(19) United States
(12) Patent Application Publication
(10) Pub. No.: US 2026/0149523 A1
(43) Pub. Date: May 28, 2026

(54) METHOD FOR NEAR 100% DUTY-CYCLE RETRODIRECTIVE BEAMFORMING

(71) Applicant: Rockwell Collins, Inc., Cedar Rapids, IA (US)

(72) Inventor: Benjamin Peiffer, Cedar Rapids, IA (US)

(21) Appl. No.: 19/311,539

(22) Filed: Aug. 27, 2025

Related U.S. Application Data
(60) Provisional application No. 63/723,951, filed on Nov. 22, 2024.

(51) Int. Cl. H04J 4/00; H04B 1/00; H04B 1/04; H04L 5/00; H04L 25/02

(52) U.S. Cl. CPC H04J 4/00; H04B 1/0003; H04B 1/04; H04L 5/0094; H04L 25/0202; H04B 2001/0416

(57) ABSTRACT

A method may use hybrid-TDMA/FDMA frames to synchronize participating nodes to an orchestrator node of a virtual antenna array as the virtual antenna array transmits to a target node. The virtual antenna array is formed by the orchestrator node and the participating nodes. The orchestrator node synchronizes the participating nodes periodically using the hybrid-TDMA/FDMA frames. The virtual antenna array directs joint communications toward and receives communication from the target node. The communication from the target node may be used to learn channel state information (CSI) between the virtual antenna array and the target node. The nodes may include software-defined radios which execute the hybrid-TDMA/FDMA frames. The hybrid-TDMA/FDMA frames may include concurrent transmissions of signal data and metadata. The hybrid-TDMA/FDMA frames may decouple the duty-cycle from the number of nodes.

### CROSS-REFERENCE

The present application claims the benefit under 35 U.S.C. § 119 of U.S. Provisional application 63/723,951, filed on Nov. 22, 2024, titled “METHOD FOR NEAR 100% DUTY-CYCLE RETRODIRECTIVE BEAMFORMING”, which is incorporated herein by reference in the entirety.

### TECHNICAL FIELD

The present disclosure generally relates to adaptive arrays, and more specifically to retrodirective arrays.

### BACKGROUND

Retrodirective distributed beamforming relies on precise phase and frequency synchronization of the independent local oscillators (LO) within a virtual antenna array (VAA) and observation of transmissions from the distant target node.

In past retrodirective beamforming work, synchronization of the transmission is performed through an iterative process where the nodes that are in the cooperating group take turns listening to one another and then they have a time slot where each participate together to reach the target node. The repetition rate of sounding intervals for synchronization depends on dynamics such as the relative stability of the LOs and the speed of movement of each node. Because the cooperating nodes are typically disadvantaged users, this synchronization process can often consume significant time, effectively reducing the duty-cycle of transmissions from the VAA to the target. Previous experimental demonstrations of retrodirective distributed beamforming in a time-division multiple-access (TDMA) scenario using quadrature phase-shift keying (QPSK) signals cause each of the nodes to take turns transmitting before organizing a coordinated transmission. Within the four nodes in a virtual antenna array, this results in an approximately 20% duty-cycle for coordinated transmissions. The duration of synchronization transmissions and guard-times can be reduced to increase the duty-cycle significantly, but adding more nodes places downward pressure on the maximum achievable duty-cycle.

Therefore, it would be advantageous to provide a device, system, and method that cures the shortcomings described above.

### SUMMARY

In some aspects, the techniques described herein relate to a radio system including: an antenna; and a software-defined radio including: a transmitter, wherein the transmitter is configured to receive signal data and metadata as frequency-domain signals from the software-defined radio, wherein the transmitter is configured to transmit the signal data and the metadata as a time-domain signal over M-number of subcarriers, wherein the transmitter includes: a complex precoder, wherein the complex precoder is configured to make a gain adjustment (Gs) and a phase adjustment (Hs) to the signal data, wherein the phase adjustment (Hs) is based on a phase offset; a filter bank multi-carrier modulator, wherein the filter bank multi-carrier modulator is configured to receive the signal data from the complex precoder, wherein the filter bank multi-carrier modulator is configured to channelize the signal data and the metadata into the time-domain signal including the M-number of subcarriers; and a digital mixer, wherein the digital mixer is configured to shift the M-number of subcarriers by a carrier frequency offset; wherein the software-defined radio is configured to update the phase offset and the carrier frequency offset using the metadata during a hybrid-TDMA/FDMA frame, wherein the hybrid-TDMA/FDMA frame includes a virtual antenna array synchronization slot and a virtual antenna array receive slot, wherein the software-defined radio is configured to transmit the signal data and the metadata and receive the metadata as the time-domain signal during the virtual antenna array synchronization slot, wherein the software-defined radio is configured to receive the signal data as the time-domain signal during the virtual antenna array receive slot.

In some aspects, the techniques described herein relate to a virtual antenna array including: an orchestrator node; and a plurality of participating nodes, wherein the orchestrator node and the plurality of participating nodes each include a radio system, wherein the radio system includes: an antenna; and a software-defined radio, wherein the software-defined radio includes: a transmitter, wherein the transmitter is configured to receive signal data and metadata as frequency-domain signals from the software-defined radio, wherein the transmitter is configured to transmit the signal data and the metadata as a time-domain signal over M-number of subcarriers, wherein the transmitter includes: a complex precoder, wherein the complex precoder is configured to make a gain adjustment (Gs) and a phase adjustment (Hs) to the signal data, wherein the phase adjustment (Hs) is based on a phase offset; a filter bank multi-carrier modulator, wherein the filter bank multi-carrier modulator is configured to receive the signal data from the complex precoder, wherein the filter bank multi-carrier modulator is configured to channelize the signal data and the metadata into the time-domain signal including the M-number of subcarriers; and a digital mixer, wherein the digital mixer is configured to shift the M-number of subcarriers by a carrier frequency offset; wherein the software-defined radio is configured to update the phase offset and the carrier frequency offset using the metadata during a hybrid-TDMA/FDMA frame, wherein the hybrid-TDMA/FDMA frame includes a virtual antenna array synchronization slot and a virtual antenna array receive slot, wherein the software-defined radio is configured to transmit the signal data and the metadata and receive the metadata as the time-domain signal during the virtual antenna array synchronization slot, wherein the software-defined radio is configured to receive the signal data as the time-domain signal during the virtual antenna array receive slot.

In some aspects, the techniques described herein relate to a retrodirective beamforming system including: a target node; and a virtual antenna array, wherein the target node and the virtual antenna array are configured to communicate via a communication link formed via radio frequency signals, wherein the radio frequency signals from the virtual antenna array arrive coherently at the target node, wherein the virtual antenna array includes: an orchestrator node; and a plurality of participating nodes, wherein the orchestrator node and the plurality of participating nodes each include a radio system, wherein the radio system includes: an antenna; and a software-defined radio, wherein the software-defined radio includes: a transmitter, wherein the transmitter is configured to receive signal data and metadata as frequency-domain signals from the software-defined radio, wherein the transmitter is configured to transmit the signal data and the metadata as a time-domain signal over M-number of subcarriers, wherein the transmitter includes: a complex precoder, wherein the complex precoder is configured to make a gain adjustment (Gs) and a phase adjustment (Hs) to the signal data, wherein the phase adjustment (Hs) is based on a phase offset; a filter bank multi-carrier modulator, wherein the filter bank multi-carrier modulator is configured to receive the signal data from the complex precoder, wherein the filter bank multi-carrier modulator is configured to channelize the signal data and the metadata into the time-domain signal including the M-number of subcarriers; and a digital mixer, wherein the digital mixer is configured to shift the M-number of subcarriers by a carrier frequency offset; wherein the software-defined radio is configured to update the phase offset and the carrier frequency offset using the metadata during a hybrid-TDMA/FDMA frame, wherein the hybrid-TDMA/FDMA frame includes a virtual antenna array synchronization slot and a virtual antenna array receive slot, wherein the software-defined radio is configured to transmit the signal data and the metadata and receive the metadata as the time-domain signal during the virtual antenna array synchronization slot, wherein the software-defined radio is configured to receive the signal data as the time-domain signal during the virtual antenna array receive slot.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 depicts a retrodirective beamforming system with a virtual antenna array including an orchestrator node and participating nodes, in accordance with one or more embodiments of the present disclosure.

FIG. 2 depicts a simplified block diagram of a radio system of the orchestrator node and participating nodes, including a software-defined radio with a transmitter, in accordance with one or more embodiments of the present disclosure.

FIG. 3 depicts the transmitter configured to channelize signal data and metadata onto subcarriers and phase and carrier frequency offsets, in accordance with one or more embodiments of the present disclosure.

FIG. 4A depicts a communication link of the retrodirective beamforming system with a stream of hybrid-TDMA/FDMA frames, in accordance with one or more embodiments of the present disclosure.

FIG. 4B depicts a time slot diagram of transmit and receive powers of the hybrid-TDMA/FDMA frames, in accordance with one or more embodiments of the present disclosure.

FIG. 5A depicts a spectral plot of signal data transmitted with metadata, where the subcarrier of the signal data is higher than the subcarrier of the metadata, in accordance with one or more embodiments of the present disclosure.

FIG. 5B depicts a spectral plot of signal data transmitted without metadata and relative to a noise floor, in accordance with one or more embodiments of the present disclosure.

FIG. 6 depicts frequency-time-power plots during the hybrid-TDMA/FDMA frames, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings. Embodiments of the present disclosure provide a method for near 100% duty-cycle retrodirective beamforming. The method may use hybrid-TDMA/FDMA frames to synchronize participating nodes to an orchestrator node of a virtual antenna array as the virtual antenna array transmits to a target node. The virtual antenna array is formed by the orchestrator node and the participating nodes. The orchestrator node synchronizes the participating nodes periodically using the hybrid-TDMA/FDMA frames. The virtual antenna array directs joint communications toward and receives communication from the target node. The communication from the target node may be used to learn channel state information (CSI) between the virtual antenna array and the target node. The nodes may include software-defined radios which execute the hybrid-TDMA/FDMA frames. The hybrid-TDMA/FDMA frames may include concurrent transmissions of signal data and metadata. The software-defined radios may include receivers with bank multi-carrier modulators to modulate the signal data and the metadata onto subcarriers. The hybrid-TDMA/FDMA frames may decouple the duty-cycle from the number of participating nodes.

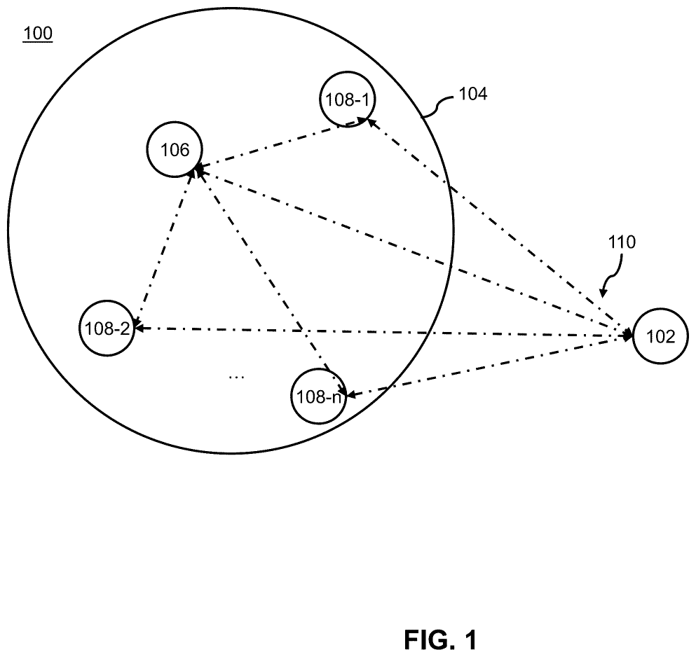

FIG. 1 depicts a retrodirective beamforming system 100, in accordance with one or more embodiments of the present disclosure. The retrodirective beamforming system 100 may include a target node 102 and/or a virtual antenna array 104 (VAA). The virtual antenna array 104 may include an orchestrator node 106 and/or participating nodes 108. The target node 102, the virtual antenna array 104, the orchestrator node 106, and/or the participating nodes 108 may be configured to communicate via a communication link 110.

The communication link 110 may be formed via radio frequency signals. A power, frequency, and phase of the radio frequency signals may be controlled to form the communication link 110. The communication link 110 may be a bidirectional link. Packets of information may be conveyed bidirectionally between the target node 102, the virtual antenna array 104, the orchestrator node 106, and/or the participating nodes 108 via the communication link 110.

The orchestrator node 106 and/or the participating nodes 108 may individually receive signals from each other via the communication link 110. For example, an individual transmit power of the orchestrator node 106 and/or the participating nodes 108 may be sufficient to be received by the remainder of the orchestrator node 106 and/or the participating nodes 108 within the virtual antenna array 104.

The orchestrator node 106 and/or the participating nodes 108 may individually receive signals from the target node 102 via the communication link 110. For example, the transmit power of the target node 102 may be sufficient to be individually received by the orchestrator node 106 and/or the participating nodes 108 over the communication link 110.

The target node 102 may not receive individual signals from the orchestrator node 106 and/or the participating nodes 108. For example, the individual transmit power of the orchestrator node 106 and/or the participating nodes 108 may be insufficient to be received by the target node 102 over the communication link 110. For instance, the orchestrator node 106 and/or the participating nodes 108 may be much closer together than the target node 102 such that the orchestrator node 106 and/or the participating nodes 108 may individually communicate with each other but may not individually communicate with the target node 102 and/or the transmit power of the target node 102 may be an order of magnitude larger than the individual transmit powers of the orchestrator node 106 and/or the participating nodes 108.

The orchestrator node 106 and/or the participating nodes 108 may use distributed multi-input multi-output (DMIMO) to enable the virtual antenna array 104 to form the communication link 110 to the target node 102. The radio frequency signals from the virtual antenna array 104 may arrive coherently at the target node 102. The orchestrator node 106 and/or the participating nodes 108 may transmit signals over the communication link 110. The signals may be timed and phased to arrive coherently at the target node 102. The coherence of the signal may increase the power such that the signal may be received by target node 102. Thus, the target node 102 may receive the signals which arrive in-phase from the virtual antenna array 104 via the communication link 110.

The target node 102 may equalize distortions common to an uplink channel from the virtual antenna array 104 to the target node 102 over the communication link 110.

The virtual antenna array 104 may also be referred to as a retrodirective array, a transmit cluster, a distributed antenna array, or the like. The retrodirective beamforming system 100 may be considered retrodirective, in that the virtual antenna array 104 may use reciprocity to learn an attenuation and a phase of a wireless channel between the target node 102 and the orchestrator node 106 without coordination from the target node 102.

The orchestrator node 106 may also be referred to as a master node. A clock signal of the orchestrator node 106 may be defined as a clock signal of the virtual antenna array 104. The orchestrator node 106 may organize the virtual antenna array 104.

The participating nodes 108 may also be referred to as slave nodes. The virtual antenna array 104 may include an integer number-n of the participating nodes 108 (e.g., participating node 108-1, participating node 108-2, . . . to participating node 108-n).

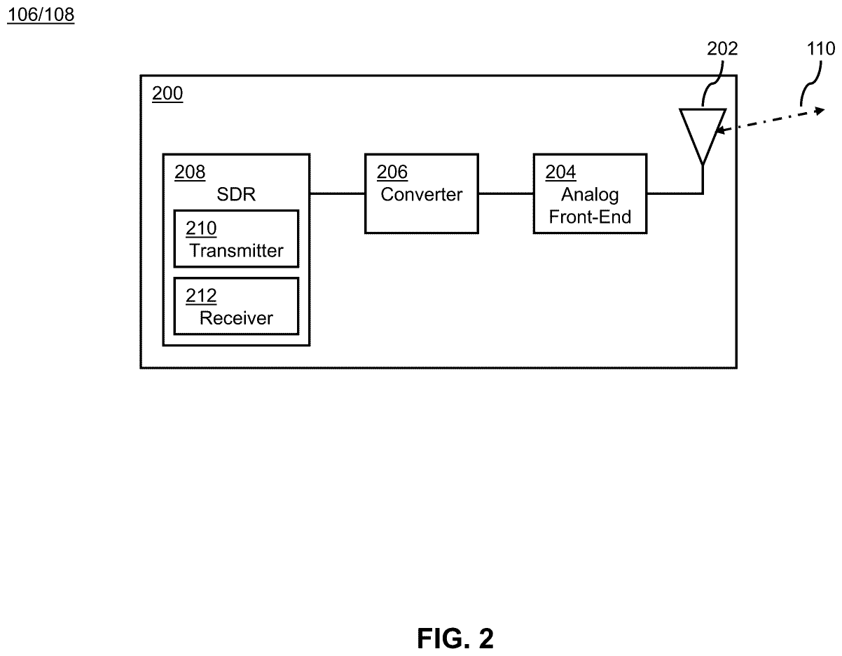

FIG. 2 depicts the orchestrator node 106 and the participating nodes 108, in accordance with one or more embodiments of the present disclosure. The orchestrator node 106 and the participating nodes 108 may each include a radio system 200. The radio system 200 may include an antenna 202, an analog front-end 204, a converter 206, and/or a software-defined radio 208 (SDR). As may be understood, the antenna 202, the analog front-end 204, the converter 206, and/or the software-defined radio 208 may include several components, permutations, and arrangements, which are not set forth herein for clarity.

The antenna 202 may include any suitable antenna, such as, but not limited to, a dipole antenna, array antenna, and the like. The antenna 202 may provide an interface for the communication link 110. The communication link 110 may be transmitted from and/or received by the antenna 202.

The analog front-end 204 may be coupled to the antenna 202. The analog front-end 204 may provide one or more functions. For example, the analog front-end 204 may perform frequency (up/down) conversion, phase shifting, splitting/combining, filtering, amplification, signal mixing, and the like.

The converter 206 may be coupled to the analog front-end 204. The converter 206 may provide one or more functions. For example, the converter 206 may convert between analog and digital signals. The converter 206 may be an analog-to-digital converter (ADC) in receive and/or a digital-to-analog converter (DAC) in transmit.

The software-defined radio 208 may be coupled to the converter 206. The software-defined radio 208 may be a digital back-end of the radio system 200. The software-defined radio 208 may provide one or more functions. For example, the software-defined radio 208 may function as a waveform processor, performing actions such as modulation and demodulation. By way of another example, the software-defined radio 208 may perform frequency (up/down) conversion, phase shifting, amplification, signal mixing, and the like. The software-defined radio 208 may include one or more components for performing said functions. For example, the software-defined radio 208 may include a transmitter 210, a receiver 212, and the like. The transmitter 210 and the receiver 212 may respectively transmit and receive via the converter 206, the analog front-end 204, and the antenna 202. The nodes may form the communication link 110 by the transmitter 210 and the receiver 212 respectively transmitting and receiving signals.

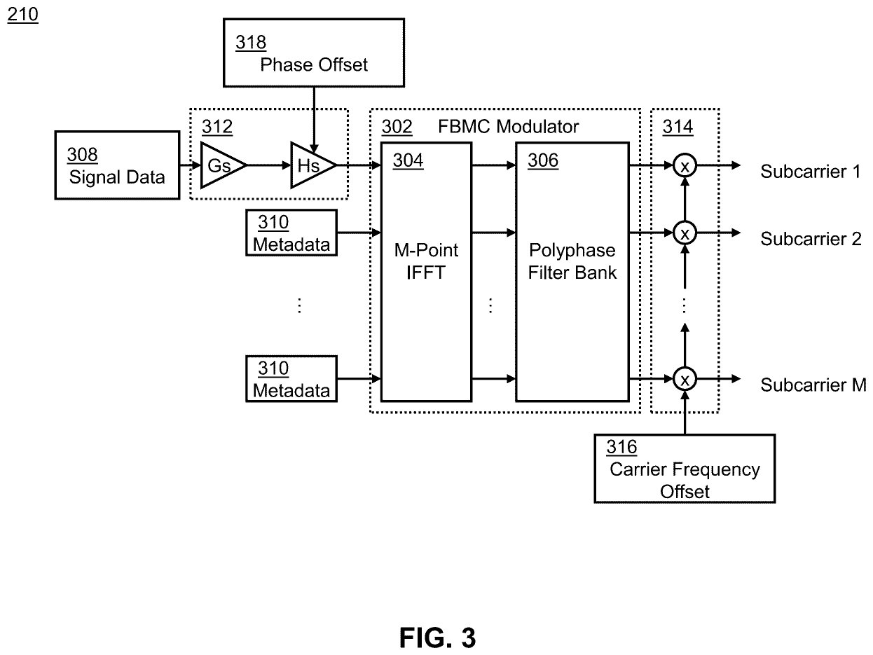

FIG. 3 depicts the transmitter 210, in accordance with one or more embodiments of the present disclosure. The transmitter 210 may receive signal data 308 and/or metadata 310 as frequency-domain signals from the software-defined radio 208 (e.g., receive from the software-defined radio 208 for transmission). The frequency-domain signals may refer to signals with a distribution of energy across different frequencies. The transmitter 210 may transmit the signal data 308 and the metadata 310 as a time-domain signal over M-number of subcarriers, where M is an integer. The time-domain signal may refer to a signal which varies over a time-domain. The transmitter 210 may transmit the signal data 308 and/or the metadata 310 over the M-number of subcarriers. The transmitter 210 may spread the signal data 308 and the metadata 310 over the subcarriers, as a spread spectrum waveform. For example, the transmitter 210 may transmit the signal data 308 over a first subcarrier and the metadata 310 over remainder of the M-number of subcarriers.

The signal data 308 may form the coordinated communications that are directed to the target node 102. The signal data 308 may include in-phase and quadrature components (I/Q components).

The metadata 310 may be used for synchronizing the participating nodes 108 to the orchestrator node 106 and/or for beamforming the phases of the signals from the virtual antenna array 104 at the target node 102. The metadata 310 may enable synchronization of the participating nodes 108 to the orchestrator node 106 within the virtual antenna array 104. The metadata 310 may include various information, such as, but not limited to, a phase offset 318, a time-of-arrival, a phase-of-arrival, a carrier frequency offset 316, and the like.

The metadata 310 may also include padding. The padding may allow the signal with the metadata 310 signal to be sufficiently in terms of the time-bandwidth-product to calculate the phase offset 318 and/or the carrier frequency offset 316.

The software-defined radio 208 may modulate the signal data 308 and/or the metadata 310 prior to transmission by the transmitter 210. The signal data 308 and/or the metadata 310 may be modulated using any suitable digital modulation. For example, the signal data 308 may be modulated amplitude-shift keying (ASK), amplitude and phase-shift keying (APSK), continuous phase modulation (CPM), frequency-shift keying (FSK), multiple frequency-shift keying (MFSK), minimum-shift keying (MSK), on-off keying (OOK), pulse-position modulation (PPM), phase-shift keying (PSK) (e.g., quadrature phase-shift keying (QPSK)), quadrature amplitude modulation (QAM), single-carrier frequency-division multiple access (SC-FDE), or the like.

The transmitter 210 may include one or more components, such as, a filter bank multi-carrier modulator 302 (FBMC modulator), a complex precoder 312, and/or a digital mixer 314.

The complex precoder 312 may adjust a complex gain of the signal data 308 before the filter bank multi-carrier modulator 302 receives the signal data 308. The complex precoder 312 may adjust the complex gain via gain and/or phase adjustment. For example, the complex precoder 312 may make a gain adjustment (Gs) and/or a phase adjustment (Hs) to the signal data 308. The complex precoder 312 may make the gain adjustment (Gs) and the phase adjustment (Hs) to the signal data 308 in either order before the filter bank multi-carrier modulator 302 receives the signal data 308.

The gain adjustment (Gs) may amplify the signal data 308 to account for propagation losses of the communication link 110 between the virtual antenna array 104 and the target node 102. The gain adjustment (Gs) may amplify the signal data 308 above the metadata 310 because the metadata 310 does not need to travel to the virtual antenna array 104. The gain adjustment (Gs) may also amplify the signal data 308 relative to the metadata 310.

The complex precoder 312 may perform the phase adjustment (Hs) based on the phase offset 318. The phase offset 318 may pre-compensate for clock offsets, electronics and propagation delays. The phase adjustment (Hs) may steer the transmission of the signal data 308 to the target node 102. The phase adjustment (Hs) may steer the signal data 308 via a beamforming technique in which the radio frequency signals from nodes of the virtual antenna array 104 combine coherently at the target node 102. The phase adjustment (Hs) may be a complex gain associated with the retrodirective beamforming. The phase adjustment (Hs) may phase-lock the signals from the virtual antenna array 104 at the target node 102. The phase adjustment (Hs) may cause the signal data 308 to arrive coherently in-phase at the target node 102. The beamforming coherence requires the precoding to correct for the relative uplink channels between the participating nodes 108 and the target node 102.

The complex precoder 312 does not adjust the metadata 310. The adjustment to the complex gain of the signal data 308 and not the metadata 310 may allow the signal data 308 to travel further than the metadata 310. Furthermore, not amplifying the metadata 310 by the gain adjustment (Gs) may be increase a likelihood that the metadata 310 is not received outside of the virtual antenna array 104.

The filter bank multi-carrier modulator 302 may receive the signal data 308 from the complex precoder 312 and may also receive the metadata 310. The filter bank multi-carrier modulator 302 may channelize the signal data 308 and the metadata 310 into a time-domain signal including M-number of subcarriers, where M is an integer number of at least two. The signal data 308 and the metadata 310 may be in one or more of the subcarriers. The signal data 308 and the metadata 310 may be channelized into separate of the subcarriers. For example, the signal data 308 may be in one of the subcarriers with the metadata 310 being in the remainder of the subcarriers. The filter bank multi-carrier modulator 302 may channelize the signal data 308 and the metadata 310 from the frequency domain signals and output as the time-domain signal. The time-domain signal may include the M-number of subcarriers.

The filter bank multi-carrier modulator 302 may include one or more components. For example, the filter bank multi-carrier modulator 302 may include an M-point inverse fast Fourier transform 304 (M-point IFFT) and/or a polyphase filter bank 306.

The M-point inverse fast Fourier transform 304 may be fed by signal data 308 and metadata 310. For example, the M-point inverse fast Fourier transform 304 may be fed by signal data 308 at channel 1 and metadata 310 at channels 2 through M. The M-point inverse fast Fourier transform 304 may perform an inverse fast Fourier transform on the signal data 308 and the metadata 310 to convert from the frequency domain to the time domain. The transmitter 210 may be configured to transmit or not transmit the metadata 310. For example, the metadata 310 may not be transmitted by zero filling the metadata channels of the M-point inverse fast Fourier transform 304. The transmitter 210 may zero filling the metadata channels of the M-point inverse fast Fourier transform 304 based on a current slot, subslot, and/or sub-subslot of a hybrid-TDMA/FDMA frame 402.

The polyphase filter bank 306 may receive the signals from the M-point inverse fast Fourier transform 304. The polyphase filter bank 306 may separate the signal into separate subcarriers. For example, the polyphase filter bank 306 may up-sample and up-convert the signals into the M-number of subcarriers. The M-number signals may be transmitted through a shift register in order. The signals may be output in order, as the time-domain signal that contains the signal data 308 and metadata 310 of all the subcarriers put together.

The digital mixer 314 may receive the time-domain signal from the filter bank multi-carrier modulator 302. For example, the digital mixer 314 receive each of the sub-carriers of the time-domain signal from the polyphase filter bank 306. The digital mixer 314 may shift the subcarriers by a carrier frequency offset 316. The carrier frequency offset 316 may frequency-lock the signals from the virtual antenna array 104. Shifting by the carrier frequency offset 316 may be performed after the polyphase filter bank 306 because the carrier frequency offset 316 may shift the whole of the output such that the signal data 308 is matching the desired frequency of arrival at the target node 102.

The digital mixer 314 may output a time-domain signal to the converter 206 for transmission via the radio system 200.

The gain adjustment (Gs) and/or the number-M of subcarriers may or may not be fixed. For example, the gain adjustment (Gs) and/or the number-M of subcarriers may be preset during initialization of the virtual antenna array 104. In embodiments, the gain adjustment (Gs) and/or the number-M of subcarriers may be chosen based on the operational scenario to balance the throughput and bit-error-rate of signal data 308 and the metadata 310. The gain adjustment (Gs) and/or the number-M of subcarriers may be selected based on a link margin to the target node 102. The gain adjustment (Gs) and/or the number-M of subcarriers may or may not be the same for each of the orchestrator node 106 and/or the participating nodes 108.

The software-defined radio 208 may update the phase offset 318 and/or the carrier frequency offset 316. The phase offset 318 and/or the carrier frequency offset 316 may be updated based on the metadata 310.

The subcarriers on which the metadata 310 is transmitted may be adjacent to and/or surround the subcarriers on which the signal data 308 is transmitted. Providing the subcarriers adjacent to or surrounding may be beneficial when updating the carrier frequency offset 316 and/or the phase offset 318. The phase offset 318 may not be a wideband characteristic so to accurately synchronize in-phase, the signal data 308 and the metadata 310 may be transmitted on subcarriers which are as close as possible in frequency.

The software-defined radio 208 may update the phase offset 318 and/or the carrier frequency offset 316 using the metadata 310 during a hybrid-TDMA/FDMA frame 402, as will be described further herein. With each of the hybrid-TDMA/FDMA frame 402, the software-defined radio 208 may update the phase offset 318 and/or the carrier frequency offset 316.

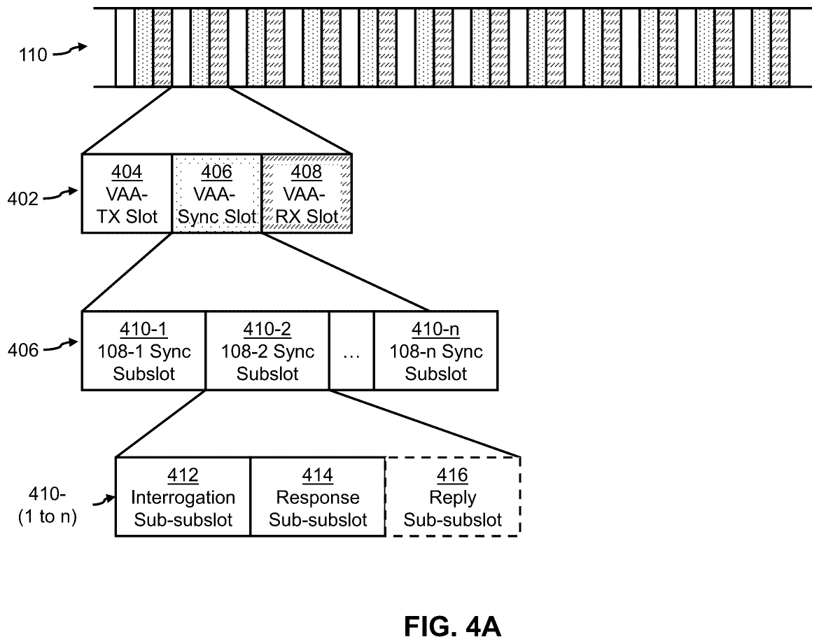

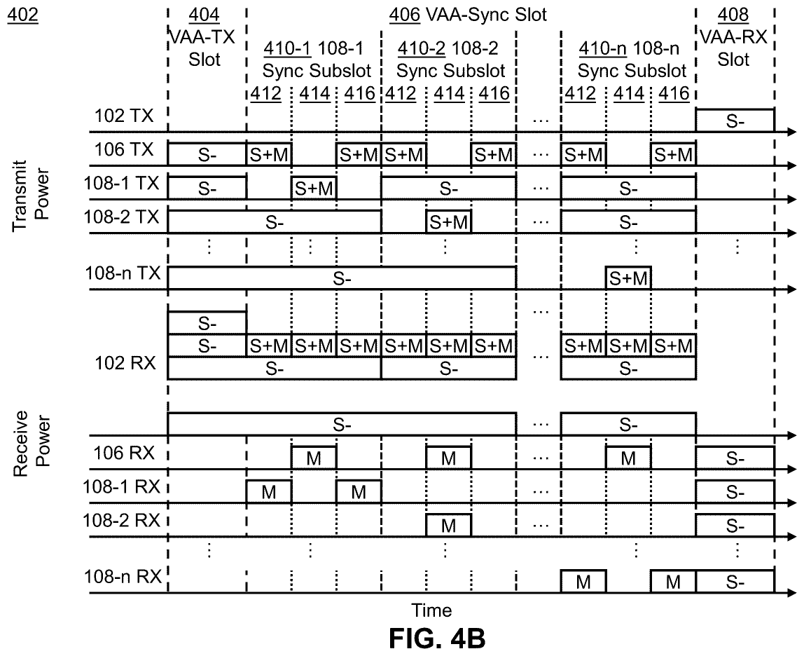

FIGS. 4A-4B depicts the communication link 110, in accordance with one or more embodiments of the present disclosure. The communication link 110 may be formed via hybrid-TDMA/FDMA frames 402 (hybrid-time division multiple access/frequency division multiple access frames). The hybrid-TDMA/FDMA frames 402 may repeat for the duration of the communication link 110. The structure of the hybrid-TDMA/FDMA frames 402 may be agreed upon by the target node 102, the virtual antenna array 104, the orchestrator node 106, and/or the participating nodes 108. The target node 102, the virtual antenna array 104, the orchestrator node 106, and/or the participating nodes 108 may form the communication link 110 via the hybrid-TDMA/FDMA frames 402.

The hybrid-TDMA/FDMA frames 402 may include one or more slots. For example, the hybrid-TDMA/FDMA frames 402 may include a VAA-transmit slot 404 (VAA-TX slot), a VAA-synchronization slot 406 (VAA-sync slot), and/or a VAA-receive slot 408 (VAA-RX slot). The VAA-transmit slot 404, the VAA-synchronization slot 406, and the VAA-receive slot 408 may repeat in sequence across the hybrid-TDMA/FDMA frames 402. The VAA-synchronization slot 406 may be between the VAA-transmit slot 404 and the VAA-receive slot 408. The VAA-synchronization slot 406 may follow the VAA-transmit slot 404. The VAA-receive slot 408 may follow the VAA-synchronization slot 406.

During the VAA-transmit slot 404, each of the orchestrator node 106 and the participating nodes 108 may transmit the signal data 308. The virtual antenna array 104 may include a coherent gain of N\hat{ }2 at the target node 102 during the VAA-transmit slot 404, where N is the number of the number of the participating nodes 108. Transmitting the signal data 308 from each of the orchestrator node 106 and the participating nodes 108 may provide the coherent gain of N\hat{ }2. The software-defined radio 208 of the orchestrator node 106 and the participating nodes 108 may be configured to transmit the signal data 308 and not the metadata 310 as the time-domain signal during the VAA-transmit slot 404.

During the VAA-synchronization slot 406, the virtual antenna array 104 may synchronize the participating nodes 108 to the orchestrator node 106. The synchronization subslots 410 may pairwise synchronize the participating nodes 108 to the orchestrator node 106. In this regard, the VAA-synchronization slot 406 is not a broadcast-type synchronization. The orchestrator node 106 and the participating nodes 108 may transmit the signal data 308 and the metadata 310 and receive the metadata 310 in a select sequence. The software-defined radio 208 of the orchestrator node 106 and the participating nodes 108 may be configured to transmit the signal data 308 and the metadata 310 and receive the metadata 310 as the time-domain signal during the VAA-synchronization slot 406. Each of the synchronization subslots 410 may synchronize a currently-synchronizing participating node 108-(current) of the participating nodes 108 with the orchestrator node 106. The orchestrator node 106 and the currently-synchronizing participating node 108-(current) may take turns transmitting and receiving the signal data 308 and the metadata 310 (indicated by “S+M”) during the synchronization subslots 410. The orchestrator node 106 and the currently-synchronizing participating node 108-(current) which transmit the signal data 308 and the metadata 310 may have a signal transmit power reduced slightly to balance a power of the signal and metadata carriers. A remainder of the participating nodes 108 which are not synchronizing (e.g., participating nodes 108-1 to 108-(current−1) and 108-(current+1) to 108-n) may continually transmit the signal data 308 and not transmit the metadata 310 (indicated by “S−”) during the synchronization subslots 410. The number of the orchestrator node 106 and the participating nodes 108 transmitting the signal data 308 is equal to the number of the participating nodes 108, with one of the orchestrator node 106 or one of the participating nodes 108 also transmitting the metadata 310 and with one of the orchestrator node 106 or the participating nodes 108 which is not transmitting the signal data 308 listening for the metadata 310. The signal only transmissions may combine coherently with the signal data 308 of the synchronization transmissions at the target node 102. The virtual antenna array 104 may include a coherent gain of (N−1)\hat{ }2 at the target node 102 during the VAA-synchronization slot 406, where N is the number of the number of the participating nodes 108. Transmitting the signal data 308 from all but one of the orchestrator node 106 or the participating nodes 108 may provide the coherent gain of (N−1)\hat{φ}2 at the target node 102. The consequence of providing said coherent gain is that the gain of the virtual antenna array 104 increases with increasing number of the participating nodes 108 even while the participating nodes 108 are synchronizing.

The VAA-synchronization slot 406 may include one or more subslots. For example, the VAA-synchronization slot 406 may include synchronization subslots 410 for each of the participating nodes 108. (e.g., participating node 108-1 synchronization subslot 410-1, participating node 108-2 synchronization subslot 410-2, . . . to participating node 108-n synchronization subslot 410-n).

Each of the synchronization subslots 410 may include one or more sub-subslots. For example, the synchronization subslots 410 may include an interrogation sub-subslot 412 and a response sub-subslot 414. The response sub-subslot 414 may follow the interrogation sub-subslot 412. The synchronization subslots 410 may optionally include a reply sub-subslot 416. The reply sub-subslot 416 may follow the response sub-subslot 414. The sub-subslots may be periodic for each of the synchronization subslots 410.

During the interrogation sub-subslot 412, the orchestrator node 106 may transmit the signal data 308 and the metadata 310. For example, the transmitter 210 of the orchestrator node 106 may transmit the signal data 308 and the metadata 310. The currently-synchronizing participating node 108-(current) of the participating nodes 108 does not transmit the signal data 308 or the metadata 310 but instead receives the metadata 310 from the orchestrator node 106. For example, the transmitter 210 of the currently-synchronizing participating node 108-(current) does not transmit the signal data 308 or the metadata 310. The remainder of the participating nodes 108 which are not synchronizing (e.g., participating nodes 108-1 to 108-(current−1) and 108-(current+1) to 108-n) transmit the signal data 308 and not the metadata 310. For example, the transmitters 210 of the remainder of the participating nodes 108 may transmit the signal data 308 and not the metadata 310. Thus, the total number of nodes during the virtual antenna array 104 during the interrogation sub-subslot 412 which are transmitting the signal data 308 is equal to the number of the participating nodes 108. The currently-synchronizing participating node 108-(current) does not process the signal data 308 from the orchestrator node 106, because the signal data 308 is not directly observable due to the signal data 308 from the remainder of the participating nodes 108 which are not synchronizing. However, the currently-synchronizing participating node 108-(current) may process the metadata 310 from the orchestrator node 106. The metadata 310 from the orchestrator node 106 may include the phase offset 318 and/or the carrier frequency offset 316 of the currently-synchronizing participating node 108-(current) from the previous hybrid-TDMA/FDMA frame 402. The currently-synchronizing participating node 108-(current) may process the metadata 310 to determine a phase-of-arrival, a time-of-arrival, a frequency-of-arrival, an effective channel gain between the orchestrator node 106 and the currently-synchronizing participating node 108-(current), the carrier frequency offset 316, the phase offset 318, or the like.

During the response sub-subslot 414, the currently-synchronizing participating node 108-(current) of the participating nodes 108 transmit the signal data 308 and the metadata 310. The orchestrator node 106 does not transmit the signal data 308 or the metadata 310 but instead receives the metadata 310 from the currently-synchronizing participating node 108-(current). The remainder of the participating nodes 108 which are not synchronizing (e.g., participating nodes 108-1 to 108-(current−1) and 108-(current+1) to 108-n) transmit the signal data 308 and not the metadata 310. Thus, the total number of nodes during the virtual antenna array 104 during the response sub-subslot 414 which are transmitting the signal data 308 is equal to the number of the participating nodes 108. The orchestrator node 106 does not process the signal data 308 from the currently-synchronizing participating node 108-(current), because the signal data 308 is not directly observable due to the signal data 308 from the remainder of the participating nodes 108. However, the orchestrator node 106 may process the metadata 310 from the currently-synchronizing participating node 108-(current). The metadata 310 from the currently-synchronizing participating node 108-(current) may include a time-of-transmission, a phase-of-transmission, the effective channel gain between the orchestrator node 106 and the currently-synchronizing participating node 108-(current), the carrier frequency offset 316, the phase offset 318, or the like. The orchestrator node 106 may process the metadata 310 to determine the phase offset 318 and/or the carrier frequency offset 316 for the currently-synchronizing participating node 108-(current). For example, the orchestrator node 106 may also determine the phase-of-arrival and the time-of-arrival. The orchestrator node 106 may compare the two sets of phase-of-arrival and time-of-arrival to determine the phase offset 318 and/or the carrier frequency offset 316.

During the reply sub-subslot 416, the orchestrator node 106 may transmit the signal data 308 and the metadata 310. The currently-synchronizing participating node 108-(current) of the participating nodes 108 does not transmit the signal data 308 or the metadata 310 but instead receives the metadata 310 from the orchestrator node 106. The remainder of the participating nodes 108 which are not synchronizing (e.g., participating nodes 108-1 to 108-(current−1) and 108-(current+1) to 108-n) transmit the signal data 308 and not the metadata 310. Thus, the total number of nodes in the virtual antenna array 104 which are transmitting the signal data 308 during the reply sub-subslot 416 is equal to the number of the participating nodes 108. The currently-synchronizing participating node 108-(current) may process the metadata 310 from the orchestrator node 106. The metadata 310 from the orchestrator node 106 may include feedback of the phase offset 318 and/or the carrier frequency offset 316 from the currently-synchronizing participating node 108-(current) in the response sub-subslot 414. The currently-synchronizing participating node 108-(current) may process the metadata 310 to update the phase adjustment (Hs) using the phase offset 318 and/or update the carrier frequency offset 316 for subsequent transmission of the signal data 308.

Although the synchronization subslots 410 are described as including the reply sub-subslot 416, this is not intended as a limitation of the present disclosure. It is contemplated that the feedback of the phase offset 318 and/or the carrier frequency offset 316 from the currently-synchronizing participating node 108-(current) in the response sub-subslot 414 may be provided from the orchestrator node 106 to the currently-synchronizing participating node 108-(current) as the metadata 310 during the interrogation sub-subslot 412 of the subsequent hybrid-TDMA/FDMA frames 402. This arrangement may be beneficial to reduce the number of sub-subframes of the synchronization subslots 410 at the cost of additional time before the participating nodes 108 update the phase offset 318 and/or the carrier frequency offset 316.

During the VAA-receive slot 408, the target node 102 transmits the signal data 308. The orchestrator node 106 and the participating nodes 108 do not transmit and instead receive the signal data 308. The software-defined radio 208 of the orchestrator node 106 and the participating nodes 108 may be configured to receive the signal data 308 as the time-domain signal during the VAA-receive slot 408. The orchestrator node 106 and the participating nodes 108 may process the signal data 308. For example, the orchestrator node 106 and the participating nodes 108 may process the signal data 308 to determine a time-of-arrival and/or an effective channel gain between the virtual antenna array 104 and the target node 102.

The hybrid-TDMA/FDMA frames may be considered near 100% duty-cycle in that the virtual antenna array 104 does not transmit during the VAA-receive slot 408 but transmits with a minimum of approximately (N−1)\hat{ }2 coherent gain at duty-cycle during all other slots. Additionally, the maximum achievable duty-cycle is not related to the number of nodes in the VAA.

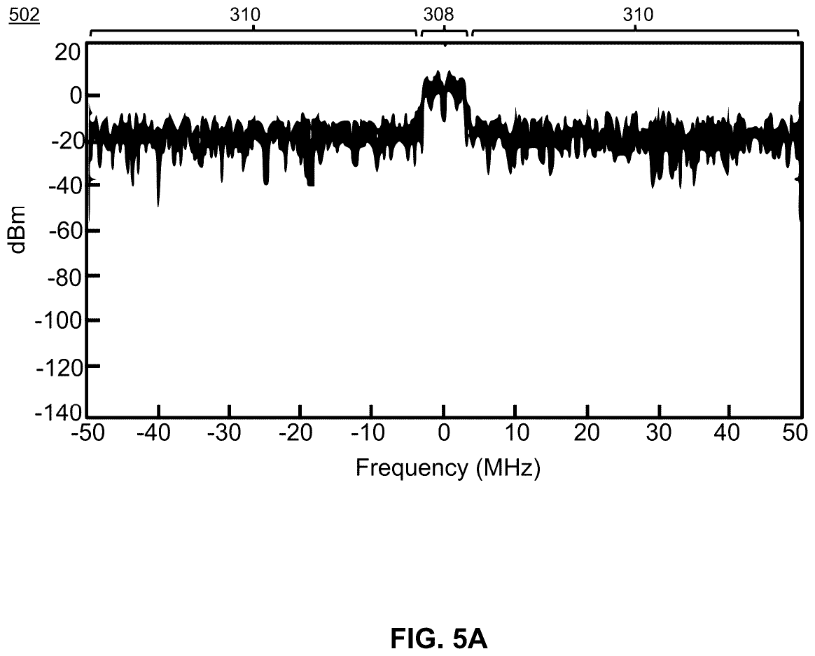

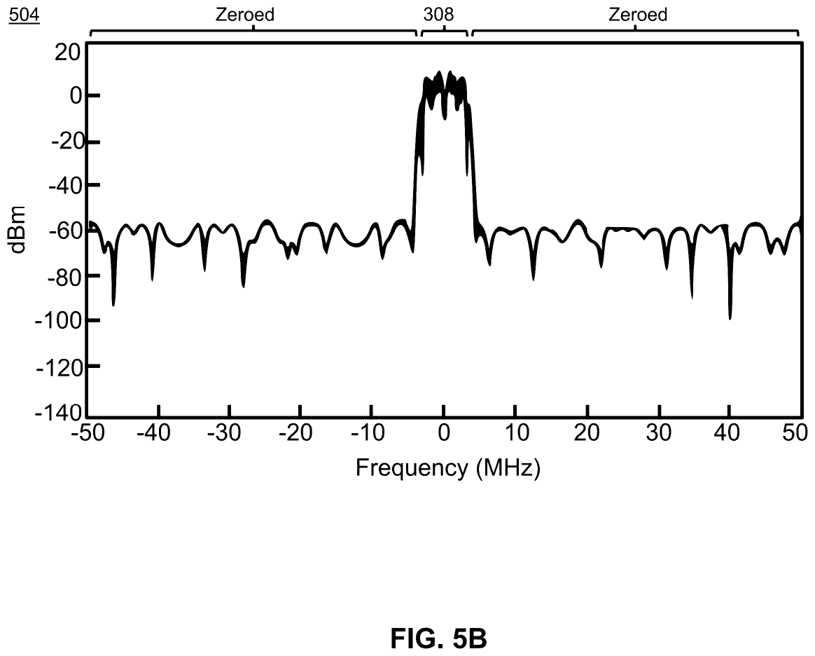

FIGS. 5A-5B depict a spectral plot 502 and spectral plot 504, in accordance with one or more embodiments of the present disclosure. The spectral plots may depict power (in dBm) as a function of frequency (in MHz). The spectral plot 502 illustrates the signal data 308 transmitted with the metadata 310. The spectral plot 504 illustrates the signal data 308 transmitted without the signal data 308 and relative to a noise floor. The frequency of the spectral plots are centered on the subcarrier of the signal data 308. In this example, the bandwidth of the communication link 110 is 100 MHz with 8 subcarriers each having a sub-bandwidth of 12.5 MHz, although this is not intended to be limiting. The metadata 310 is transmitted with about 20 dBm less power than the signal data 308. The noise floor is 60 dBm less than the signal data 308 and 40 dBm less than the metadata 310. The bandwidth, number of subcarriers, the power of the signal data 308 relative to the metadata 310, and/or the power of the signal data 308 relative to the noise floor is exemplary and is not intended to be limiting.

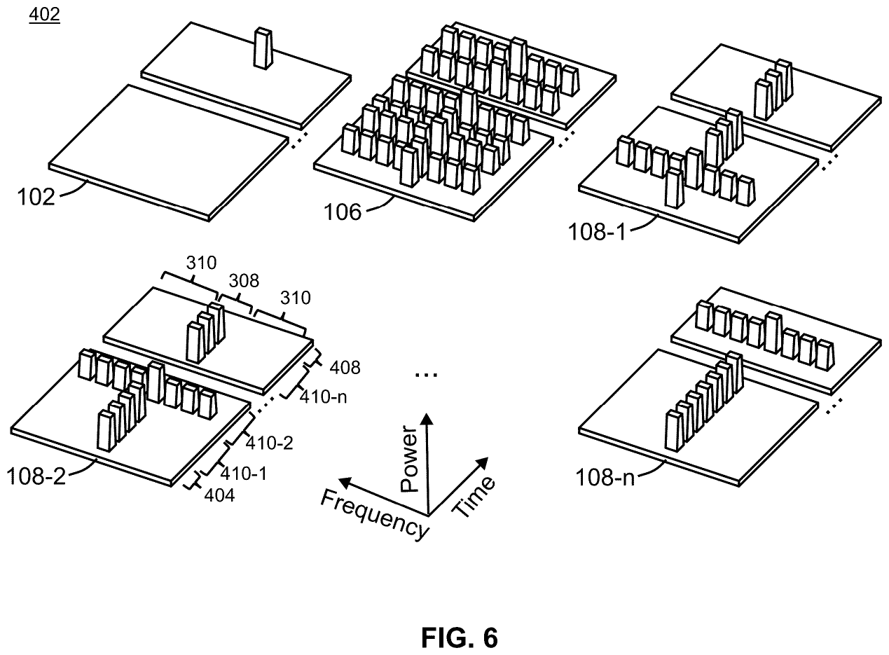

FIG. 6 depicts frequency-time-power plots, in accordance with one or more embodiments of the present disclosure. The frequency-time-power plots are during one of the hybrid-TDMA/FDMA frames 402. The frequency-time-power plots are for the transmissions of the target node 102, the orchestrator node 106, and the participating nodes 108. In this example, the signal data 308 is in the fifth subcarrier and the metadata 310 is in the remainder of the eight subcarriers. The noise floor is 60 dBm less than the signal data 308 and 40 dBm less than the metadata 310.

Referring generally again to the figures.

The hybrid-TDMA/FDMA frames 402 do not provide a continuous side channel via the subcarriers for synchronizing the participating nodes 108. Instead, the participating nodes 108 share the side channel based on the order of the synchronization subslots 410. Sharing the side channel may be advantageous to reduce a likelihood of detection of the metadata 310.

The hybrid-TDMA/FDMA frames 402 may include a repetition rate. The repetition rate may be the rate at which the hybrid-TDMA/FDMA frames 402 repeat. The repetition rate of the hybrid-TDMA/FDMA frames 402 and/or the relative duration of the VAA-transmit slot 404 to the VAA-synchronization slot 406 may be dependent on the rate at which the information gained degrades due to time, frequency, and positional uncertainty. The orchestrator node 106 and/or the participating nodes 108 may experience a significant amount of time and frequency uncertainty and therefore must synchronize very frequently. For example, the relative speed at which the target node 102, the orchestrator node 106, and/or the participating nodes 108 are moving relative to one another may cause the channels to change quicker and so then the updates need to happen faster. In some embodiments, the VAA-transmit slot 404 may be reduced or removed to provide extra time for the VAA-synchronization slot 406 in the hybrid-TDMA/FDMA frames 402.

It is contemplated that the virtual antenna array 104 may include some upper bounds on the number of the participating nodes 108. One limitation on the number of the participating nodes 108 may be based on the dynamic range of the receiver 212. The receiver 212 may include sufficient dynamic range to prevent the signal data 308 from jamming the metadata 310 during the VAA-synchronization slots 406. For example, the receiver 212 may include sufficient dynamic range to receive the metadata 310 during the VAA-synchronization slots 406 and to receive the signal data 308 from the target node 102 during the VAA-receive slots 408. The signal data 308 may arrive within the virtual antenna array 104 with random phase relative to one another, so the gain at the receiver 212 on average would be a gain of N. Such gain provides an upper bound on the number of the participating nodes 108 before self-jamming.

A software-defined radio (or digital radio) may be a radio that functions like a computer, where the functionality of the radio is defined by software that can be upgraded, rather than by fixed hardware. The software-defined radio may be a radio whose signal processing functionality is defined in software, where the waveforms are generated as sampled digital signals, converted from digital to analog via a high-speed Digital-to-Analog Converter (D/A) and then translated to Radio Frequency (RF) for wireless propagation. The software-defined radio may be characterized by software executing on microprocessors and configurations loaded into programmable hardware such as field programmable gate arrays (FPGAs). The software-defined radio may be implemented via one or more modules.

A module can take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the modules can include any type of component for accomplishing or facilitating achievement of the operations described herein. For example, a circuit as described herein can include one or more transistors, logic gates (e.g., NAND, AND, NOR, OR, XOR, NOT, XNOR, etc.), resistors, multiplexers, registers, capacitors, inductors, diodes, wiring, and so on), and programmable hardware devices (e.g., field programmable gate arrays, programmable array logic, programmable logic devices or the like). The modules can include a processor and one or more memory devices for storing instructions that are executable by each of the processors.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period. For example, the memory may be random access memory (RAM), and the results may not necessarily persist indefinitely in the memory.

It is noted herein that the one or more components of system may be communicatively coupled to the various other components of system in any manner known in the art. For example, the one or more processors may be communicatively coupled to each other and other components via a wireline connection or wireless connection.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A radio system comprising:
an antenna; and
a software-defined radio comprising:
a transmitter, wherein the transmitter is configured to receive signal data and metadata as frequency-domain signals from the software-defined radio, wherein the transmitter is configured to transmit the signal data and the metadata as a time-domain signal over M-number of subcarriers, wherein the transmitter comprises:
a complex precoder, wherein the complex precoder is configured to make a gain adjustment (Gs) and a phase adjustment (Hs) to the signal data, wherein the phase adjustment (Hs) is based on a phase offset;
a filter bank multi-carrier modulator, wherein the filter bank multi-carrier modulator is configured to receive the signal data from the complex precoder, wherein the filter bank multi-carrier modulator is configured to channelize the signal data and the metadata into the time-domain signal including the M-number of subcarriers; and
a digital mixer, wherein the digital mixer is configured to shift the M-number of subcarriers by a carrier frequency offset;
wherein the software-defined radio is configured to update the phase offset and the carrier frequency offset using the metadata during a hybrid-TDMA/FDMA frame, wherein the hybrid-TDMA/FDMA frame includes a virtual antenna array synchronization slot and a virtual antenna array receive slot, wherein the software-defined radio is configured to transmit the signal data and the metadata and receive the metadata as the time-domain signal during the virtual antenna array synchronization slot, wherein the software-defined radio is configured to receive the signal data as the time-domain signal during the virtual antenna array receive slot.

2. The radio system of claim 1, comprising an analog front-end and a converter, wherein the analog front-end is coupled to the antenna, wherein the converter is coupled to the analog front-end, wherein the software-defined radio is coupled to the converter.

3. The radio system of claim 1, wherein the complex precoder does not adjust the metadata.

4. The radio system of claim 1, wherein the filter bank multi-carrier modulator includes an M-point inverse fast Fourier transform and a polyphase filter bank.

5. The radio system of claim 4, wherein the transmitter is configured to not transmit the metadata by zero filling metadata channels of the M-point inverse fast Fourier transform.

6. The radio system of claim 1, wherein the signal data and the metadata are channelized into separate of the M-number of subcarriers.

7. The radio system of claim 1, wherein the hybrid-TDMA/FDMA frame includes a virtual antenna array transmit slot, wherein the software-defined radio is configured to transmit the signal data and not the metadata as the time-domain signal during the virtual antenna array transmit slot.

8. The radio system of claim 7, wherein the virtual antenna array synchronization slot is between the virtual antenna array transmit slot and the virtual antenna array receive slot.

9. A virtual antenna array comprising:
an orchestrator node; and
a plurality of participating nodes, wherein the orchestrator node and the plurality of participating nodes each comprise a radio system, wherein the radio system comprises:
an antenna; and
a software-defined radio, wherein the software-defined radio comprises:
a transmitter, wherein the transmitter is configured to receive signal data and metadata as frequency-domain signals from the software-defined radio, wherein the transmitter is configured to transmit the signal data and the metadata as a time-domain signal over M-number of subcarriers, wherein the transmitter comprises:
a complex precoder, wherein the complex precoder is configured to make a gain adjustment (Gs) and a phase adjustment (Hs) to the signal data, wherein the phase adjustment (Hs) is based on a phase offset;
a filter bank multi-carrier modulator, wherein the filter bank multi-carrier modulator is configured to receive the signal data from the complex precoder, wherein the filter bank multi-carrier modulator is configured to channelize the signal data and the metadata into the time-domain signal including the M-number of subcarriers; and
a digital mixer, wherein the digital mixer is configured to shift the M-number of subcarriers by a carrier frequency offset;
wherein the software-defined radio is configured to update the phase offset and the carrier frequency offset using the metadata during a hybrid-TDMA/FDMA frame, wherein the hybrid-TDMA/FDMA frame includes a virtual antenna array synchronization slot and a virtual antenna array receive slot, wherein the software-defined radio is configured to transmit the signal data and the metadata and receive the metadata as the time-domain signal during the virtual antenna array synchronization slot, wherein the software-defined radio is configured to receive the signal data as the time-domain signal during the virtual antenna array receive slot.

10. The virtual antenna array of claim 9, wherein the virtual antenna array synchronization slot includes a plurality of synchronization subslots, wherein the plurality of synchronization subslots include an interrogation sub-subslot and a response sub-subslot, wherein the response sub-subslot follows the interrogation sub-subslot.

11. The virtual antenna array of claim 10, wherein each of the plurality of synchronization subslots synchronizes a currently-synchronizing participating node of the plurality of participating nodes with the orchestrator node, wherein a remainder of the plurality of participating nodes which are not the currently-synchronizing participating node transmit the signal data and do not transmit the metadata during the interrogation sub-subslot and the response sub-subslot.

12. The virtual antenna array of claim 11, wherein the orchestrator node transmits the signal data and the metadata during the interrogation sub-subslot, wherein the currently-synchronizing participating node does not transmit and receives the metadata from the orchestrator node during the interrogation sub-subslot, wherein the currently-synchronizing participating node is configured to update the phase offset and the carrier frequency offset using the metadata from the orchestrator node.

13. The virtual antenna array of claim 12, wherein the currently-synchronizing participating node transmits the signal data and the metadata during the response sub-subslot, wherein the orchestrator node does not transmit and receives the metadata from the currently-synchronizing participating node during the response sub-subslot, wherein the orchestrator node is configured to process the metadata from the currently-synchronizing participating node to determine the phase offset and the carrier frequency offset for the currently-synchronizing participating node.

14. The virtual antenna array of claim 13, wherein the plurality of synchronization subslots include a reply sub-subslot, wherein the reply sub-subslot follows the interrogation sub-subslot, wherein the orchestrator node transmits the signal data and the metadata including the phase offset and the carrier frequency offset for the currently-synchronizing participating node during the reply sub-subslot, wherein the orchestrator node does not transmit and receives the metadata from the orchestrator node during the reply sub-subslot, wherein the remainder of the plurality of participating nodes which are not the currently-synchronizing participating node transmit the signal data and do not transmit the metadata during the reply sub-subslot.

15. The virtual antenna array of claim 13, wherein the orchestrator node transmits the metadata including the phase offset and the carrier frequency offset for the currently-synchronizing participating node during the interrogation sub-subslot of a subsequent hybrid-TDMA/FDMA frame.

16. A retrodirective beamforming system comprising:
a target node; and
a virtual antenna array, wherein the target node and the virtual antenna array are configured to communicate via a communication link formed via radio frequency signals, wherein the radio frequency signals from the virtual antenna array arrive coherently at the target node, wherein the virtual antenna array comprises:
an orchestrator node; and
a plurality of participating nodes, wherein the orchestrator node and the plurality of participating nodes each comprise a radio system, wherein the radio system comprises:
an antenna; and
a software-defined radio, wherein the software-defined radio comprises:
a transmitter, wherein the transmitter is configured to receive signal data and metadata as frequency-domain signals from the software-defined radio, wherein the transmitter is configured to transmit the signal data and the metadata as a time-domain signal over M-number of subcarriers, wherein the transmitter comprises:
a complex precoder, wherein the complex precoder is configured to make a gain adjustment (Gs) and a phase adjustment (Hs) to the signal data, wherein the phase adjustment (Hs) is based on a phase offset;
a filter bank multi-carrier modulator, wherein the filter bank multi-carrier modulator is configured to receive the signal data from the complex precoder, wherein the filter bank multi-carrier modulator is configured to channelize the signal data and the metadata into the time-domain signal including the M-number of subcarriers; and
a digital mixer, wherein the digital mixer is configured to shift the M-number of subcarriers by a carrier frequency offset;
wherein the software-defined radio is configured to update the phase offset and the carrier frequency offset using the metadata during a hybrid-TDMA/FDMA frame, wherein the hybrid-TDMA/FDMA frame includes a virtual antenna array synchronization slot and a virtual antenna array receive slot, wherein the software-defined radio is configured to transmit the signal data and the metadata and receive the metadata as the time-domain signal during the virtual antenna array synchronization slot, wherein the software-defined radio is configured to receive the signal data as the time-domain signal during the virtual antenna array receive slot.

17. The retrodirective beamforming system of claim 16, wherein the virtual antenna array includes a coherent gain of (N−1)\hat{ }2 at the target node during the virtual antenna array synchronization slot, where N is a number of the plurality of participating nodes.

18. The retrodirective beamforming system of claim 16, wherein the hybrid-TDMA/FDMA frame includes a virtual antenna array transmit slot, wherein the software-defined radio is configured to transmit the signal data and not the metadata as the time-domain signal during the virtual antenna array transmit slot.

19. The retrodirective beamforming system of claim 18, wherein the virtual antenna array includes a coherent gain of N\hat{ }2 at the target node during the virtual antenna array transmit slot, where N is a number of the plurality of participating nodes.

20. The retrodirective beamforming system of claim 16, wherein the hybrid-TDMA/FDMA frame repeats for a duration of the communication link.
